(19) United States
(12) Patent Application Publication
(10) Pub. No.: US 2026/0361373 A1
(43) Pub. Date: Nov. 12, 2026

(54) SYSTEMS AND METHODS FOR BEAM REPORTING FOR NETWORK BASED ARTIFICIAL INTELLIGENCE BEAM MANAGEMENT

(71) Applicant: APPLE INC., Cupertino, CA (US)

(72) Inventors: Weidong Yang, San Diego, CA (US); Huaning Niu, San Jose, CA (US); Dawei Zhang, Saratoga, CA (US); Wei Zeng, San Diego, CA (US); Oghenekome Oteri, San Diego, CA (US); Chunxuan Ye, San Diego, CA (US); Seyed Ali Akbar Fakoorian, San Diego, CA (US)

(21) Appl. No.: 19/109,214

(22) PCT Filed: Aug. 10, 2023
(86) PCT No.: PCT/US2023/072048

§ 371 Date: Mar. 6, 2025

Related U.S. Application Data
(60) Provisional application No. 63/376,790, filed on Sep. 23, 2022.

(51) Int. Cl. H04B 7/06; H04B 17/318

(52) U.S. Cl. CPC H04B 7/06952; H04B 17/328

(57) ABSTRACT

Systems and methods for beam reporting for network based artificial intelligence (AI) beam management are discussed herein. A network transmits reference signals corresponding to one or more beams to a user equipment (UE), and the UE responds with a beam report indicating its measurement of the reference signals on the corresponding beams. An AI model at the network is capable of using the indicated measurement so formulate a beam indication to send to the UE. Various embodiments herein relate to the methods of performing beam reporting between the UE and the network in such contexts. Embodiments for using a set of absolute reference signal received power (RSRP) values in a beam report; for using (e.g., quantized/threshold-modified) difference series in a beam report; and for using differential RSRP values in a beam report are discussed. Cases where fewer than all the transmitted beams are included in the beam report are discussed.

### CROSS-REFERENCE TO RELATED APPLICATIONS

The present application claims the benefit of priority to the filing date of U.S. Provisional Patent Application No. 63/376,790 filed Sep. 23, 2022, entitled, “BEAM REPORTING FOR NETWORK BASED AI BEAM MANAGEMENT,” the contents of which are incorporated herein by reference in their entirety.

### TECHNICAL FIELD

This application relates generally to wireless communication systems, including wireless communications systems implementing beam management mechanisms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a signaling diagram illustrating a model procedure for network-side training and network-side inference generation, according to embodiments discussed herein.

FIG. 2 illustrates a table for bit widths for a CRI, an SSBRI, an absolute RSRP, and a differential RSRP, as may be used in some beam reporting designs.

FIG. 3 illustrates a table that maps/orders CSI fields of a report corresponding to CRI/RSRP reporting or SSBRI/RSRP reporting (as the case may be).

FIG. 4 illustrates an indexed table corresponding to a general use of the formula

$${Σ}_{n - 1}^{N} {C}_{M - {a}_{n}}^{N + 1 - n}$$

under a combinatorial indexing mechanism.

FIG. 5 illustrates an example of the use of separate sub-ranges under a combinatorial indexing scheme with respect to N₁ and N₂, according to various embodiments.

FIG. 6 illustrates a method of a UE, according to embodiments discussed herein.

FIG. 7 illustrates a method of a UE, according to embodiments discussed herein.

FIG. 8 illustrates a method of a UE, according to embodiments discussed herein.

FIG. 9 illustrates a method of a UE, according to embodiments discussed herein.

FIG. 10 illustrates a method of a RAN, according to embodiments discussed herein.

FIG. 11 illustrates a method of a RAN, according to embodiments discussed herein.

FIG. 12 illustrates a method of a RAN, according to embodiments discussed herein.

FIG. 13 illustrates a method of a RAN, according to embodiments discussed herein.

FIG. 14 illustrates an example architecture of a wireless communication system, according to embodiments disclosed herein.

FIG. 15 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

It has been determined that the use of artificial intelligence (AI) for purposes of beam management within a wireless communication system operable to perform transmissions in a beamformed manner may be beneficial in at least some contexts. More specifically, the use of an AI model for purposes of analyzing a beam report received from a remote entity may be useful (as will be discussed in additional detail below).

In some embodiments, it is proposed that a single sided model should be used, wherein the AI model is an implementation-specific model at one of a UE or a base station. For example, if the AI model is located at the UE, then training of the AI model and/or inference generation using the AI model may be performed at the UE/by the UE. If, on the other hand, the AI model is located at the base station, then training of the AI model and/or inference generation using the AI model may be performed at the base station/by base station.

Assistance information may be used in certain of these implementations. For example, through internal investigation, it is found that a loading with respect to direct Fourier transform (DFT) beams that are the subject of a beam report can be unequal. Thus, there may be a need to improve or optimize an analog beam design, which may no longer be amenable for DFT precoding.

In some cases, the AI model in question may be a neural network (NN) model useful for the analysis of/inference generation based on one or more beam measurements (e.g., in a received beam report). There may be at least two sets of beams associated with the use of such NN models. A first set of beams (“Set A”) may include beams for which the NN model generates a prediction.

A second set of beams (“Set B”) may include beams that are transmitted for purpose of generating measurements for use as inputs to the NN model to generate the prediction of the Set A beams (and where Set B may contain all or fewer than all of the Set A beams and/or beam(s) that are not in the Set A).

A third set of beams (“Set C”) may include beams that are actually reported for use in/as inputs to the NN model (and where Set C may contain all or fewer than all of the Set B beams). Note that in cases where Set C includes fewer beams than Set B, it may be that all the Set B beams were measured, but only the measurements for the Set C beams are reported and subsequently used with the NN model. In alternative cases where Set C includes fewer beams than Set B, it may be that only the Set B beams that are also found in Set C were actually measured and then subsequently used in the NN model. In other cases, where Set C includes all the Set B beams, it may be understood that the Set B itself represents the measurements that are used as input to the NN. It should be understood that in some optional cases, the NN model may also use as inputs default values for beams not reported in Set C.

Finally, a fourth set of beams (“Set D”) may include reported beams from Set C that were measured at a level where the actual measured values are used in the report for those beams (as opposed to a default/canned value being used for those beams). Accordingly, it should be understood that Set D may contain all or fewer than all of the Set C beams.

In certain systems, for AI/machine learning (ML)-based beam management purposes, support may be provided for a pair of cases, beam management (BM)-Case1 and BM-Case2, useful for characterization and baseline performance evaluation purposes. BM-Case1 includes the generation of a spatial-domain downlink (DL) beam prediction for Set A of beams based on measurement results of Set B, Set C, and/or Set D of beams (as the case may be). BM-Case2 includes the generation of a temporal DL beam prediction for Set A beams based on historic measurement results of Set B, Set C, and/or Set D of beams (as the case may be). For each of BM-Case1 and BM-Case2, Beams in Set A, Set B, Set C, and/or Set D may be in the same frequency range.

Within BM-Case1, a pair of alternatives may be considered. In the first alternative, AI/ML-based inference generation for the prediction is implemented at the network/base station side, while in the second alternative, AI/ML-based inference generation for the prediction is implemented at the UE side.

Further, within BM-Case2, a pair of alternatives may be considered. In the first alternative, AI/ML inference generation for the prediction is implemented at the network/base station side, while in the second alternative, AI/ML inference generation for the prediction is implemented at the UE side.

Within BM-Case2, measurement results of K latest measurement instances (where K≥1) may be used as input to the AI/ML model (and note that the value of K may be up to a particular implementation at the device).

Further, within BM-Case2, the output of the AI/ML model may include F predictions for F future time instances, where each individual prediction is for an individual time instance (and where F is at least one, with other (greater) value(s) of F may be used in a particular implementation at the device).

Note that as used herein, the terms “AI model,” “ML model,” and/or “NN model” may be used interchangeably.

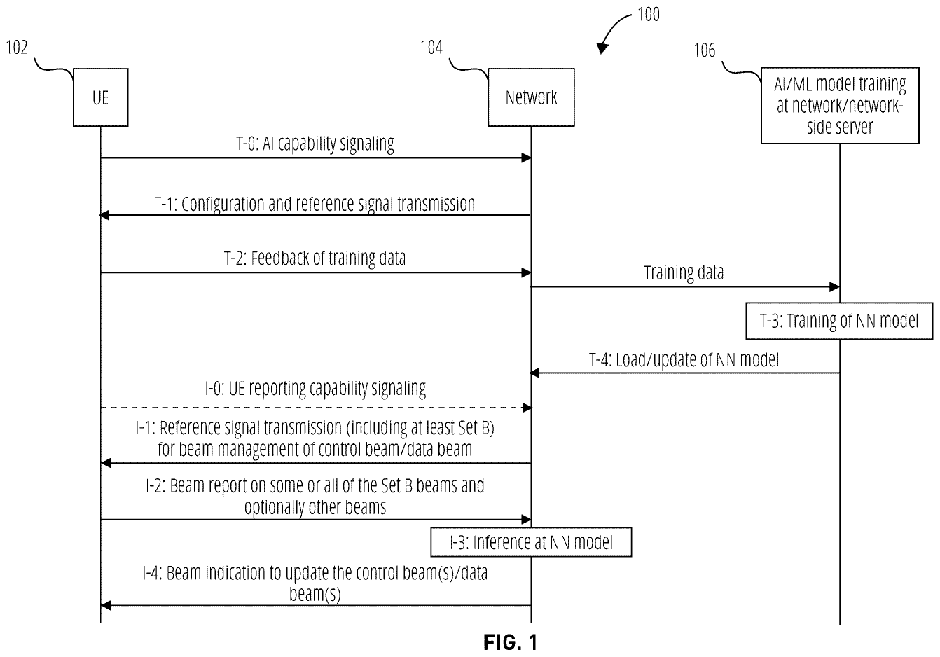

FIG. 1 is a signaling diagram 100 illustrating a model procedure for network-side training and network-side inference generation, according to embodiments discussed herein. The example shows training steps (T-steps) and inference steps (I-steps). However, skilled persons will recognize from the disclosure herein that the steps can be performed in a different order than that shown and that there may not be strict chronological requirements between the T-steps and the I-steps.

In a training step T-0, a UE 102 sends AI capability signaling to a network 104. In a training step T-1, the network 104 responds by sending a configuration and reference signal transmission to the UE 102. In a training step T-2, based on the configuration and measurements of the reference signal, the UE 102 generates and sends training data to the network 104, which the network 104 provides to AI/ML model training service 106, which may exist either directly internal to the network 104 or at a separate network-side server (as illustrated). In a training step T-3, the AI/ML model training service 106 performs training of an NN model. In a training step T-4, the AI/ML model training service 106 loads or updates the trained NN model into an NN engine of the network 104.

In an optional inference step I-0, the UE 102 may indicate to the network 104 that it is capable of using the NN model to generate a beam report type that is used by the NN model. In an inference step I-1, the network 104 sends reference signal transmission on a set of beams (using at least a Set B, as described above) for beam management with respect one or more control beam(s) and/or data beam(s). In an inference step I-2, the UE 102 sends a beam report on some or all of the Set B beams (e.g., may be sent for the Set B beams, the Set C beams, the Set D beams, and/or other/additional beams) to the network 104. In an inference step I-3, the network 104 performs inference generation with the trained NN model to infer transmit beam(s) that should be used by the network 104 as control and/or data beam(s) and which should be indicated to the UE 102. In an inference step I-4, the network 104 sends a beam indication to the UE 102 to update identify these control beam(s)/data beam(s) to the UE.

Note that prior to the beam indication at I-4, if the network 104 is unsure of the inferred transmit beams generated a I-3, the network 104 may transmit a number of candidate beams from Set A (that are not part of the Set B already transmitted) to the UE 102, and the UE 102 may report corresponding reference signal received powers (RSRPs), the best transmit beam, etc. back to the network 104. Similarly, for a UE-side implementation, the same need may arise.

In the example of FIG. 1, which (as described) uses network-side model training and network-side inference, it is possible that analog beam design information is embedded in/inherent to the training data.

To enhance the procedure represented by the signaling diagram 100, improvements to T2 and I-2 that contemplate an increase to the number of reported beams may be considered. However, such an increase to the number of reported beams may also increase feedback overhead.

Accordingly, for beam reporting for network based AI beam management, certain embodiments herein are directed to T-2 and I-2 with respect to beam reporting for the use of the same at the NN model.

In certain wireless communication systems (e.g., 3GPP Release 15 (Rel-15)), for beam reporting design, the strongest beam is used as a reference, and differential RSRPs for other beams (e.g., three other beams in some cases) are reported along with the strongest beam's RSRP and beam index.

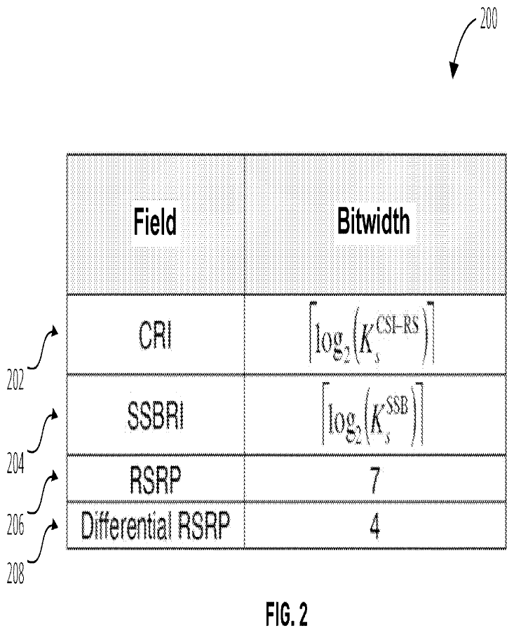

FIG. 2 illustrates a table 200 for bit widths for a channel state information reference signal (CSI-RS) resource indicator (CRI) 202, a synchronization signal block (SSB) resource block indicator (SSBRI) 204, an absolute RSRP 206, and a differential RSRP 208, as may be used in some beam reporting designs. In the table 200,

$${K}_{S}^{CSI - RS}$$

is a number of CSI-RS resources in a corresponding CSI-RS resource set (e.g., that is transmitted for measurement). Further,

$${K}_{S}^{SSB}$$

is a configured number of SSBs (or synchronization signal (SS)/physical broadcast channel (WCH) blocks) in a corresponding resource set for reporting an ssb-Index-RSRP (e.g., that are transmitted for measurement).

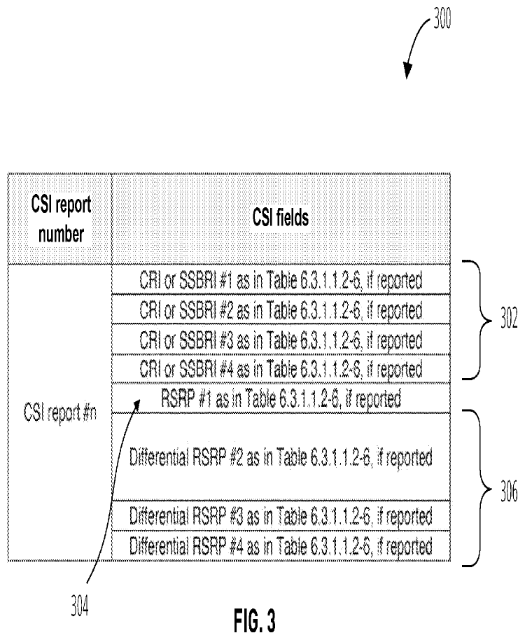

FIG. 3 illustrates a table 300 that maps/orders channel state information (CSI) fields of a report corresponding to CRI/RSRP reporting or SSBRI/RSRP reporting (as the case may be).

Referring to the table 300, it can be seen that an overhead with respect CSI reporting methods using the represented CSI report format can be understood with respect to 1) overhead due to beam index signaling (e.g., the reporting of CRIs or SSBRIs in the first four CSI fields 302 of the table 300) and 2) overhead due to RSRP reporting (e.g., the reporting of an absolute RSRP in the fifth CSI field 304 of the table 300 and the reporting differential RSRPs in the sixth through eighth CSI fields 306 of the table 300).

Embodiments discussed herein for AI based beam management relate to the generation of a beam report having a low or lowered overhead with respect to other possible implementations. In such embodiments, it may be assumed that there are a number M beams in Set B.

In such cases where all M beams in Set B are ultimately reported, then beam indexing signaling may not be needed (and thus the use of beam index signaling for all the reported beams as in table 300 may be relatively inferior).

Further, in such cases where some number N beams from Set B, where M≥N, (e.g., a Set C of beams) are ultimately reported (e.g., such as a case where a time-varying beam selection of N beams from Set B may be used), then the overhead is given by N┌log₂(M)┐. For example, if M=32, N=8, then N┌log₂(M)┐=40 (bits).

### Cases of M=N

It may be that when M=N, no signaling for beam indexing/mapping between M and N is needed in the beam report (as each of the M beams is being reported on in N).

In some cases where M=N, differential RSRP is not used. In some such cases, it may be that M occasions of absolute RSRP values (one for each beam in Set B) are reported. Such cases may accordingly be understood to correspond to/use a constant payload size. The number of bits for an RSRP (denoted Nabs) in such cases can be, but is not required to be, seven bits. This number of bits may be configured via radio resource control (RRC) signaling or via a medium access control control element (MAC CE).

In other cases where M=N and differential RSRP is not used, it may be that a non-constant payload size is used. As a general matter, it may be loosely expected that there is at least some correlation among the RSRP measurements. Given a series RSRP(1), RSRP(2), . . . , RSRP(M), the largest RSRP may be selected as a reference (e.g., RSRP(r)) as the basis for the formation of a difference series Δ(m)=RSRP(m)−RSRP(r), 1≤m≤M, where Δ(m)≤0. This difference series may then be provided in the beam report. A beam index for the beam with the largest RSRP may also be indicated in the feedback.

Various adjustments (including, e.g., scalar quantization and/or source encoding) may be performed to the difference series Δ(m), as will now be described.

As it may not be particularly meaningful to report very small RSRP values, under one such adjustment, one or more value in the difference series Δ(m) may be adjusted/modified with respect to a threshold to generate a threshold difference series Δτ(m). As part of this process, the RSRP value represented by each element of Δ(m) may be compared to a threshold RSRP value (e.g. −30 decibels (dB)) and, if the RSRP value represented by that element is lower than the RSRP threshold, the element may be accordingly adjusted to represent at least the threshold RSRP value.

It may also be that the difference series Δ(m) (and/or the threshold difference series Δτ(m)) is quantized to generate a quantized difference series. For this quantization, each value of Δ(m) (or of Δτ(m), as the case may be) may be quantized using a quantizer Q(x), resulting in quantized difference series Δ_{q}(m). In some embodiments, Q(x) may be a uniform quantizer. In other embodiments, Q(x) may be a non-uniform quantizer. In some such cases, the non-uniform quantizer Q(x) may be denser around zero, and sparser around an RSRP threshold (e.g., an RSRP threshold used to generate a threshold difference series Δτ(m) as described above, or some other RSRP threshold not related to the generation of a threshold difference series Δτ(m)).

In some embodiments, a source coding technique may be applied to Δ_{q}(m) (or to Δ(m) or Δτ(m), as the case may be). This source coding technique may be, for example, a losless source coding scheme such as a Lemple-Ziv coding technique, a Huffman coding technique, etc. The source coding technique may be applied to the input sequence (Δ_{q}(m) or Δ(m) or Δτ(m), as the case may be) (e.g., after quantization) to generate an encoded bit sequence B which is then included in the beam report.

Note that the length of bit sequence B may vary with different input sequences (according to the non-constant payload size case under discussion). To facilitate network processing, the length of encoding bit sequence B may be also provided in the CSI/beam report.

In some cases, a vector quantization may be applied to one of Δ(m) or Δτ(m) or Δ_{q}(m) as have been described herein, and the result may be included in the beam report. Vector quantization may be used in cases where a compression ratio (as compared to the source coding technique) is better under the vector quantization than under another method (better than a compression ratio of a source coding technique, as described herein). Note that when vector quantization is used to achieve a relatively better compression ratio, a tradeoff between overhead in the beam report and processing time occurs.

In some cases where M=N, differential RSRP is used. In such cases, the strongest beam's index is identified, the absolute RSRP of that strongest beam is provided, and differential RSRPs (calculated with respect to the absolute RSRP of the strongest beam) are provided for the rest of the beams. In a first example, the UE may report a first field (a “Field-A”) having the strongest beam's index s, (e.g., in terms of ┌log₂(M)┐ bits), a second field (a “Field-B”) having the absolute RSRP for the strongest beam in Nabs bits, e.g., 7 bits]; and Field-C for M−1 differential RSRP values from beam 1 to beam M, excluding the strongest beam.

Note that in such cases, Field-A, Field-B and Field-C may be arranged/ordered in various different number of ways. Examples of such arrangements/orderings may include, for example: [Field-A][Field-B][Field-C]; [Field-A][Field-C][Field-B]; and/or [Field-A] and then [Field-B inserted after the differential RSRP for beam s−1 in Field-C], where s corresponds to the strongest beam.

### Cases of M≥N

In certain embodiments, when M≥N, (where N is accordingly allowed to be/may be different from M), a bitmap is used to indicate the beam indices for the beams for which a beam report provides associated explicit beam reporting. In the bitmap, a “1” may be used to signify an explicit report for an associated beam. A beam index for the beam with the strongest RSRP may also be indicated in the feedback.

In a first alternative (Alt. 1), the bitmap comprises M bits, where M is the number of beams in Set B. In an example where M=16 and N=4, a bitmap indicating that RSRP values in the beam report correspond to beams 1, 3, 5, and 6 is [1010 1100 0000 0000].

In a second alternative (Alt. 2), a number of sets are configured to the UE, with each set having a fixed subgroup/representing a fixed subset of beam indices corresponding to the beams from Set B (the full set of transmitted beams). In this case, the UE reports the selected configured set index with its beam reporting/in the bitmap of the beam report. As an example, suppose that a first configured set corresponds to beams {1, 3, 4, and 5} and that a second configured set corresponds to beams {1, 7, 8, and 9}. In one beam reporting occasion, the UE selects to report on the first configured set of beams (and accordingly indicates the index of the first configured set of beams in the bitmap of the beam report).

Note that under Alt. 2, the cardinality of each of the configured sets need not be the same. For example, it may be that a first configured set corresponds to, e.g., four beams (e.g., beams {1, 3, 4, and 5}), while a second configured set corresponds to, e.g., five beams (e.g., beams {1, 7, 8, 9, and 10}).

In some cases, rather than using a bitmap to identify the beam reported in the beam report, an index value provided in the beam report is generated (and later interpreted) according to a combinatorial indexing mechanism, where the index value is understood to correspond to a set of beam indexes (a₁, a₂, . . . a_{N}). The beam index for the beam with the strongest RSRP may be indicated in the feedback.

Optionally/alternatively, a combinatorial indexing mechanism where the index value is understood to correspond to a set of beam indexes (a₁, a₂, . . . a_{N}) without including the beam index for the beam with the strongest RSRP may be used to further reduce signaling overhead. In that case, the network side decodes the indication for the beam index for the beam with the strongest RSRP and the combinatorial index to recover the whole set of beam indexes. In one example, assume a set of beam indexes (a₁, a₂, . . . a_{N}) is sorted in ascending order, if a₂ is the beam index with the strongest beam, then instead of generating a combinatorial index for (a₁, a₂, a₃, . . . a_{N}) over 1 to N, the UE generates another combinatorial index for (a₁, (a₃)−1, . . . (a_{N})−1) over 1 to (N−1).

In general, the index value for a particular set of beams (a₁, a₂, . . . a_{N}) that is given in the beam report may be given/understood by

$${Σ}_{n - 1}^{N} {C}_{M - {a}_{n}}^{N + 1 - n}$$

It is further noted that cases with a result of

$${C}_{x}^{y}$$

where y>x are defined as

$${C}_{x}^{y} = 0$$

such that the indexing formula is valid for every combination. Note also that alternative embodiments for notating C may use

$${C}_{y}^{x}$$

(instead of the format

$${C}_{x}^{y}$$

used herein). With respect to such embodiments, this is a notation difference only. The application of the format

$${C}_{x}^{y}$$

with respect to C as used herein will be apparent from context.

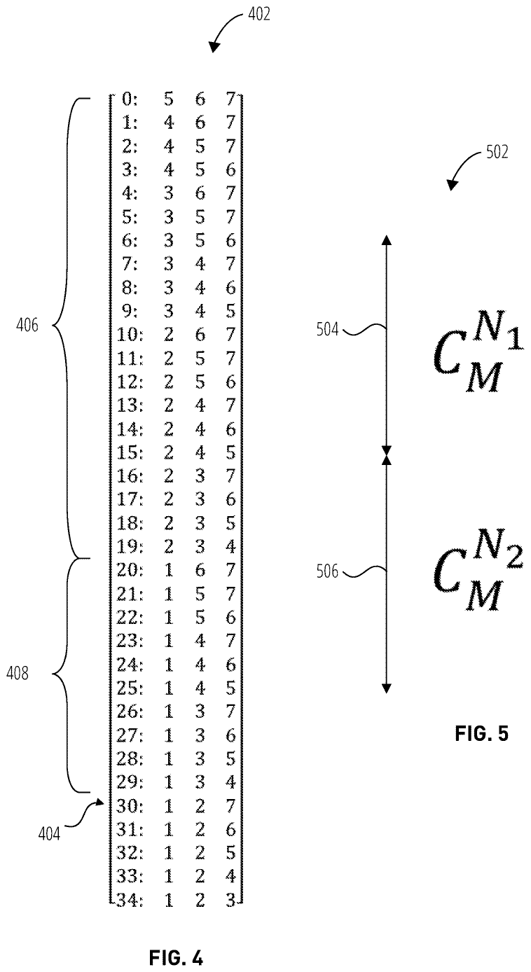

For illustrative purposes, an example of the use of this formula in a combinatorial indexing scheme will now be provided for a case where N=3 and M=7. FIG. 4 illustrates an indexed table 402 corresponding to a general use of the formula

$${\sum }_{n - 1}^{N} {C}_{M - {a}_{n}}^{N + 1 - n}$$

under a combinatorial indexing mechanism, assuming N=3 and M=7, and is provided to facilitate discussion with respect to this example.

With N=3, the combinatorial index is an index that is given to a combination (a₁, a₂, a₃), with (a₁, a₂, a₃) sorted in ascending order. Further, in this example, it is assumed that the UE wishes to indicate the N=3 beams corresponding to beam indexes (1, 2, 7), meaning that the use of

$${\sum }_{n - 1}^{N} {C}_{M - {a}_{n}}^{N + 1 - n}$$

should result in the sending of an index value 30 404 within the indexed table 402, consistent with the illustration given in FIG. 4. Details of how this result is reached under the formula will now be provided.

First, the number of combinations with (x, *, *) and x>a₁ is counted. Using

$${C}_{M - {a}_{n}}^{N + 1 - n}$$

with n=1, this is given by

$${C}_{7 - 1}^{3 + 1 - 1} = {C}_{6}^{3} = 20.$$

This corresponds to the number of the first entries 406 as indicated in FIG. 4, of which there are 20.

Then, the number of remaining combinations with (1, b′, *) and b′>a₂ is counted. Using

$${C}_{M - {a}_{n}}^{N + 1 - n}$$

with n=2, this is given by

$$= {C}_{7 - 2}^{3 + 1 - 2} = {C}_{5}^{2} = 10.$$

This corresponds to the number of the second entries 408, of which there are 10.

Finally, the number of remaining combinations with (1, 2, b″) and b″>a₂ is counted. Using

$${C}_{M - {a}_{n}}^{N + 1 - n}$$

with n=3, this is given by

$${C}_{7 - 7}^{3 + 1 - 3} = {C}_{0}^{1} = 0.$$

This is consistent with the indexed table 402, as there are zero entries with b″>7.

Accordingly, the index value corresponding to the entry (1, 2, 7) may be determined by adding the total number of counted combinations. In this case, this addition is 20+10+0=30, corresponding to the ultimate use of the index value 30 404.

Using analogous processes, the network, upon receiving the index value 30 404 from the UE in the beam report, will understand that beam indexes (1, 2, 7) have been indicated.

As another example, the use of the formula

$${\sum }_{n - 1}^{N} {C}_{M - {a}_{n}}^{N + 1 - n}$$

in a combinatorial indexing mechanism as described will now be provided in a case where N=4 and M=16. In this example, the (a₁, a₂, a₃, a₄) that is intended to be indicated by the UE may be (1, 3, 5, 6). In such a case, the use of the formula

$${\sum }_{n - 1}^{N} {C}_{M - {a}_{n}}^{N + 1 - n}$$

as described above provides that the index for (1, 3, 5, 6) under the combinatorial indexing mechanism is

$${C}_{16 - 1}^{4} + {C}_{16 - 3}^{4 - 1} + {C}_{16 - 5}^{4 - 2} + {C}_{16 - 6}^{4 - 3} = 1365 + 268 + 55 + 10 = 1 , 698.$$

Note the computation of the combinatorial index and decoding the combinatorial index on the receiver side can be simplified through the use of precalculated values for

$${C}_{x}^{y} ,$$

for assumed values of x and y. Further, in the case

$${C}_{x}^{y}$$

is a huge number, e.g., consisting of more than one hundred bits, algorithms for performing addition/subtraction with huge numbers over an eight bit or 16 bit digital signal processor (DSP) are available. In such a manner, a computational complexity for the combinatorial indexing mechanism can be made manageable.

Depending on the strength of beams, it may happen the number of selected beams N may be different for different beam reporting occasions. For example, in one report, N=4, while in another report, N=5. Accordingly, with respect to the use of the combinatorial indexing scheme (where N is assumed to be known in order to use the formula), a pair of alternatives are considered for accounting for this possible variability of N.

In a first alternative, the value of N is explicitly signaled in the beam report (along with the combinatorial index and any measurement values, etc.). In a first mechanism for explicitly signaling the value of N, a beam selection field size may be assumed to be a largest one among

$${C}_{M}^{{N}_{1}} , {C}_{M}^{{N}_{2}} ,$$

etc. for various values of N. Note that in the case for an actually applicable/used Nₓ where fewer bits are nominally needed than are available from the field size determined according to the largest possibility in the described manner, padding bits can be added.

In a second mechanism for explicitly signaling the value of N, it may be that the indication of N is carried CSI part-1, and remaining beam selection information is carried in CSI part-2.

In a second alternative, the combinatorial index ranges may be concatenated such that more efficient encoding over cases where an explicit signaling for the value of N is used can be achieved. In such cases, if N is allowed to take a value in a range (for example, 3, 4, 5), then it may be intuitively seen by concatenating the reverse lexicographically listed combinations with N=3 and N=4 that a separate subrange of indices can be assigned to N=4 and N=5 respectively. In such cases, the decoding work is reduced to the decoding problem for a fixed N, where subrange i is made up of

$${C}_{M}^{{N}_{i}} = 4 ,$$

5, etc. FIG. 5 illustrates an example 502 of the use of separate sub-ranges under a combinatorial indexing scheme with respect to N₁ and N₂, according to various embodiments. In FIG. 5, the first sub-range 504 corresponds to a use of N₁ and the second sub-range 506 corresponds to a use of N₂.

In certain embodiments, when M≥N, similar to the case with M=N, differential RSRP may not be used. In some such cases, it may be that N occasions of absolute RSRP values are reported. Such cases may accordingly be understood to correspond to/use a constant payload size. The number of bits for an RSRP (denoted N_{abs}) in such cases can be, but is not required to be, seven bits. This number of bits may be configured via RRC signaling or via a MAC CE.

In other cases where M≥N and differential RSRP is not used, it may be that a non-constant payload size is used. As a general matter, it may be loosely expected that there is at least some correlation among the RSRP measurements. Given a series, RSRP(1), RSRP(2), . . . , RSRP(N), the largest RSRP may be selected as a reference (e.g., RSRP(r)) as the basis for the formation of a difference series Δ(n)=RSRP(n)−RSRP(r), 1≤n≤N, where Δ(n)≤0. This difference series may then be provided in the beam report.

Various adjustments (including, e.g., scalar quantization and/or source encoding) may be performed to the difference series Δ(n), as will now be described.

As it may not be particularly meaningful to report very small RSRP values, under one such adjustment, one or more value in the difference series Δ(n) may be adjusted modified with respect to a threshold to generate a threshold difference series Δτ(n). As part of this process, the RSRP value represented by each element of Δ(n) may be compared to a threshold RSRP value (e.g., −30 dB) and, if the RSRP value represented by that element is lower than the RSRP threshold, the element may be accordingly adjusted to represent at least the threshold RSRP value.

It may also be that the difference series Δ(n) (and/or the threshold difference series Δτ(n)) is quantized to generate a quantized difference series. For this quantization, each value of Δ(n) (or of Δτ(n), as the case may be) may be quantized using a quantizer Q(x), resulting in quantized difference series Δ_{q}(n). In some embodiments, Q(x) may be a uniform quantizer. In other embodiments, Q(x) may be a non-uniform quantizer. In some such cases, the non-uniform quantizer Q(x) may be denser around zero, and sparser around an RSRP threshold (e.g., an RSRP threshold used to generate a threshold difference series Δτ(n) as described above, or some other RSRP threshold not related to the generation of a threshold difference series Δτ(n)).

In some embodiments, a source coding technique may be applied to Δ_{q}(n) (or to Δ(n) or Δτ(n), as the case may be). This source coding technique may be, for example, a Lemple-Ziv coding technique, a Huffman coding technique, etc. The source coding technique may be applied to the input sequence (Δ_{q}(n) or Δ(n) or Δτ(n), as the case may be) to generate an encoded bit sequence B which is then included in the beam report.

Note that the length of bit sequence B may vary with different input sequences (according to the non-constant payload size case under discussion). To facilitate network processing, the length of encoding bit sequence B may be also provided in the CSI/beam report.

In some cases, a vector quantization may be applied to one of Δ(n) or Δτ(n) or Δ_{q}(n) have as described herein, and the result may be included in the beam report. Vector quantization may be used in cases where a compression ratio (as compared to the source coding technique) is better under the vector quantization than under another method (better than a compression ratio of a source coding technique, as described herein). Note that when vector quantization is used to achieve a relatively better compression ratio, a tradeoff between overhead in the beam report and processing time occurs.

In some cases where M≥N, differential RSRP is used. In such cases, the strongest beam's index is identified, the absolute RSRP of that strongest beam is provided, and differential RSRPs (calculated with respect to the absolute RSRP of the strongest beam) are provided for the rest of the beams. In a first example, the UE may report a first field (a “Field-A”) having the strongest beam's index s, (e.g., in terms of ┌log₂(M)┐ bits), a second field (a “Field-B”) having the absolute RSRP for the strongest beam in Nabs bits, e.g., 7 bits]; and Field-C for N−1 differential RSRP values from beam 1 to beam N, excluding the strongest beam.

Note that in such cases, Field-A, Field-B and Field-C may be arranged/ordered in various different number of ways. Examples of such arrangements/orderings may include, for example: [Field-A][Field-B][Field-C]; [Field-A][Field-C][Field-B]; and/or [Field-A] and then [Field-B inserted after the differential RSRP for beam s−1 in Field-C], where s corresponds to the strongest beam.

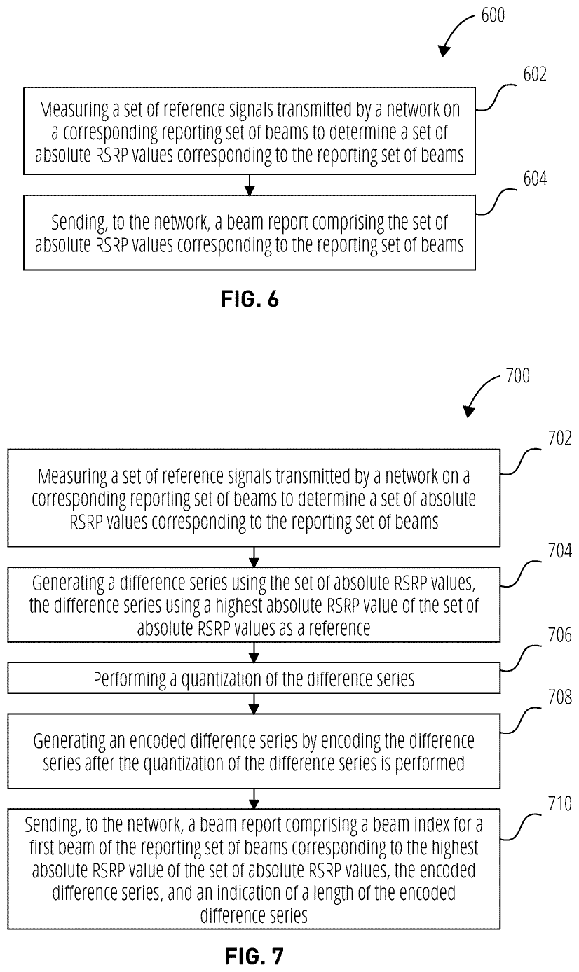

FIG. 6 illustrates a method 600 of a UE, according to embodiments discussed herein. The method 600 includes measuring 602 a set of reference signals transmitted by a network on a corresponding reporting set of beams to determine a set of absolute RSRP values corresponding to the reporting set of beams. The method 600 further includes sending 604, to the network, a beam report comprising the set of absolute RSRP values corresponding to the reporting set of beams.

In some embodiments of the method 600, each absolute RSRP value in the set of absolute RSRP values is represented in the beam report using seven bits.

In some embodiments, the method 600 further includes receiving, from the network, one of a MAC CE and RRC signaling indicating a number of bits to use to represent each absolute RSRP value of the set of RSRP values in the beam report, and wherein each absolute RSRP value in the set of absolute RSRP values is represented in the beam report using the number of bits.

In some embodiments, the method 600 further includes sending, to the network, a capability message indicating that the UE is capable of providing the beam report comprising the set of absolute RSRP values corresponding to the reporting set of beams.

In some embodiments of the method 600, the reporting set of beams is equal to a transmission set of beams transmitted by the network.

In some embodiments of the method 600, the reporting set of beams comprises a subset of a transmission set of beams transmitted by the network; and the beam report further comprises a bitmap that maps the set of absolute RSRP values corresponding to the reporting set of beams to the transmission set of beams.

In some embodiments, the method 600 further includes receiving, from the network, configuration information for one or more subsets of a transmission set of beams transmitted by the network; and selecting a first subset of the one or more subsets of the transmission set of beams as the reporting set of beams; wherein the beam report further includes an indication of the selection of the first subset of the one or more subsets of the transmission set of beams as the reporting set of beams.

In some embodiments of the method 600, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

FIG. 7 illustrates a method 700 of a UE, according to embodiments discussed herein. The method 700 includes measuring 702 a set of reference signals transmitted by a network on a corresponding reporting set of beams to determine a set of absolute RSRP values corresponding to the reporting set of beams. The method 700 further includes generating 704 a difference series using the set of absolute RSRP values, the difference series using a highest absolute RSRP value of the set of absolute RSRP values as a reference. The method 700 further includes performing 706 a quantization of the difference series. The method 700 further includes generating 708 an encoded difference series by encoding the difference series after the quantization of the difference series is performed. The method 700 further includes sending 710, to the network, a beam report comprising a beam index for a first beam of the reporting set of beams corresponding to the highest absolute RSRP value of the set of absolute RSRP values, the encoded difference series, and an indication of a length of the encoded difference series.

In some embodiments, the method 700 further includes setting any values in the difference series that are lower than a minimum threshold value to the minimum threshold value prior to performing the quantization of the difference series.

In some embodiments of the method 700, the quantization of the difference series is performed using a uniform quantizer.

In some embodiments of the method 700, the quantization of the difference series is performed using a non-uniform quantizer that is relatively sparser around the minimum threshold value.

In some embodiments of the method 700, the difference series is encoded to generate the encoded difference series using one of a Lemple-Ziv coding technique and a Huffman coding technique.

In some embodiments, the method 700 further includes sending, to the network, a capability message indicating that the UE is capable of providing the beam report comprising the beam index for the first beam, the encoded difference series, and the indication of the length of the encoded difference series.

In some embodiments of the method 700, the reporting set of beams is equal to a transmission set of beams transmitted by the network.

In some embodiments of the method 700, the reporting set of beams comprises a subset of a transmission set of beams transmitted by the network; and the beam report further comprises a bitmap that maps the set of absolute RSRP values corresponding to the reporting set of beams to the transmission set of beams.

In some embodiments, the method 700 further includes receiving, from the network, configuration information for one or more subsets of a transmission set of beams transmitted by the network; and selecting a first subset of the one or more subsets of the transmission set of beams as the reporting set of beams; wherein the beam report further includes an indication of the selection of the first subset of the one or more subsets of the transmission set of beams as the reporting set of beams.

In some embodiments of the method 700, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

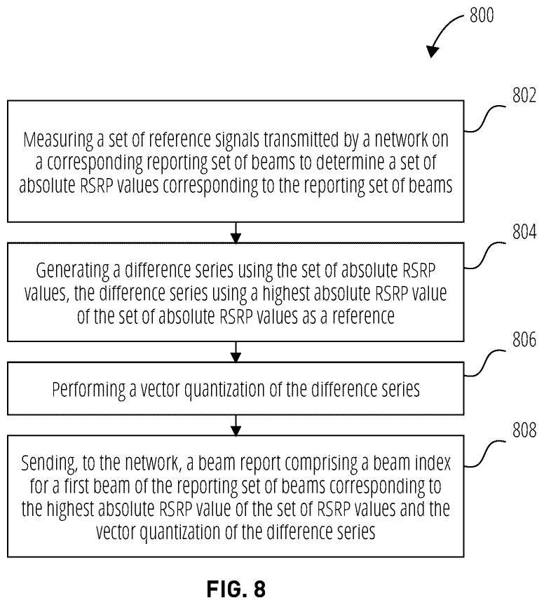

FIG. 8 illustrates a method 800 of a UE, according to embodiments discussed herein. The method 800 includes measuring 802 a set of reference signals transmitted by a network on a corresponding reporting set of beams to determine a set of absolute RSRP values corresponding to the reporting set of beams. The method 800 further includes generating 804 a difference series using the set of absolute RSRP values, the difference series using a highest absolute RSRP value of the set of absolute RSRP values as a reference. The method 800 further includes performing 806 a vector quantization of the difference series. The method 800 further includes sending 808, to the network, a beam report comprising a beam index for a first beam of the reporting set of beams corresponding to the highest absolute RSRP value of the set of RSRP values and the vector quantization of the difference series.

In some embodiments, the method 800 further includes setting any values in the difference series that are lower than a minimum threshold value to the minimum threshold value prior to the vector quantization of the difference series.

In some embodiments, the method 800 further includes performing a quantization of the difference series prior to the vector quantization of the difference series. In some such embodiments, the quantization of the difference series is performed using a uniform quantizer. In some such embodiments, the quantization of the difference series is performed using a non-uniform quantizer that is relatively sparser around a minimum threshold value.

In some embodiments, the method 800 further includes sending, to the network, a capability message indicating that the UE is capable of providing the beam report comprising the beam index for the first beam and the vector quantization of the difference series.

In some embodiments of the method 800, the reporting set of beams is equal to a transmission set of beams transmitted by the network.

In some embodiments of the method 800, the reporting set of beams comprises a subset of a transmission set of beams transmitted by the network; and the beam report further comprises a bitmap that maps the set of absolute RSRP values corresponding to the reporting set of beams to the transmission set of beams.

In some embodiments, the method 800 further includes receiving, from the network, configuration information for one or more subsets of a transmission set of beams transmitted by the network; and selecting a first subset of the one or more subsets of the transmission set of beams as the reporting set of beams; wherein the beam report further includes an indication of the selection of the first subset of the one or more subsets of the transmission set of beams as the reporting set of beams.

In some embodiments of the method 800, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

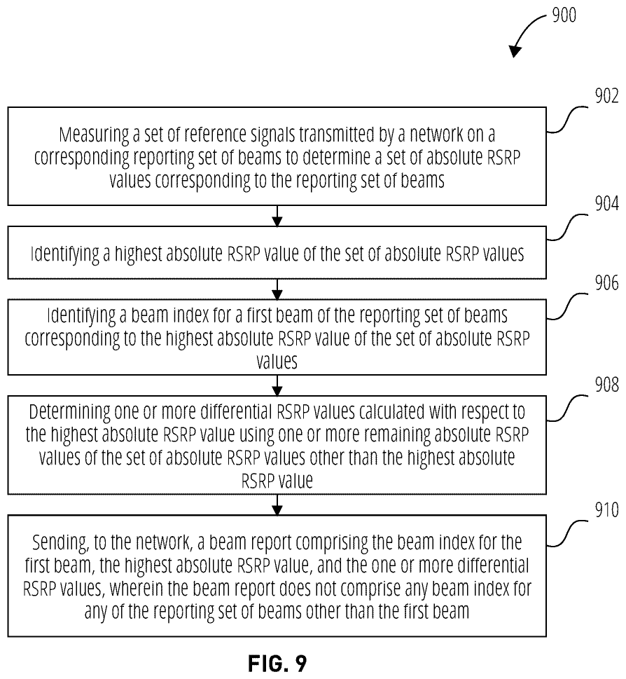

FIG. 9 illustrates a method 900 of a UE, according to embodiments discussed herein. The method 900 includes measuring 902 a set of reference signals transmitted by a network on a corresponding reporting set of beams to determine a set of absolute RSRP values corresponding to the reporting set of beams. The method 900 further includes identifying 904s a highest absolute RSRP value of the set of absolute RSRP values. The method 900 further includes identifying 906 a beam index for a first beam of the reporting set of beams corresponding to the highest absolute RSRP value of the set of absolute RSRP values. The method 900 further includes determining 908 one or more differential RSRP values calculated with respect to the highest absolute RSRP value using one or more remaining absolute RSRP values of the set of absolute RSRP values other than the highest absolute RSRP value. The method 900 further includes sending 910, to the network, a beam report comprising the beam index for the first beam, the highest absolute RSRP value, and the one or more differential RSRP values, wherein the beam report does not comprise any beam index for any of the reporting set of beams other than the first beam.

In some embodiments of the method 900, an ordering within the beam report comprises first the beam index, then then highest absolute RSRP value, then the one or more differential RSRP values.

In some embodiments of the method 900, an ordering within the beam report comprises first the beam index, then the one or more differential RSRP values, then the highest absolute RSRP value.

In some embodiments of the method 900, an ordering within the beam report comprises first the beam index and then a set of RSRP values comprising the one or more differential RSRP values and the highest absolute RSRP value, wherein the set of RSRP values is ordered according to beam indexes of corresponding ones of the reporting set of beams.

In some embodiments of the method 900, the highest absolute RSRP value is represented in the beam report using seven bits.

In some embodiments the method 900 further includes sending, to the network, a capability message indicating that the UE is capable of providing the beam report comprising the beam index for the first beam, the highest absolute RSRP value, and the one or more differential RSRP values.

In some embodiments of the method 900, the reporting set of beams is equal to a transmission set of beams transmitted by the network.

In some embodiments of the method 900, the reporting set of beams comprises a subset of a transmission set of beams transmitted by the network; and the beam report further comprises a bitmap that maps the set of absolute RSRP values corresponding to the reporting set of beams to the transmission set of beams.

In some embodiments, the method 900 further includes receiving, from the network, configuration information for one or more subsets of a transmission set of beams transmitted by the network; and selecting a first subset of the one or more subsets of the transmission set of beams as the reporting set of beams; wherein the beam report further includes an indication of the selection of the first subset of the one or more subsets of the transmission set of beams as the reporting set of beams.

In some embodiments of the method 900, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

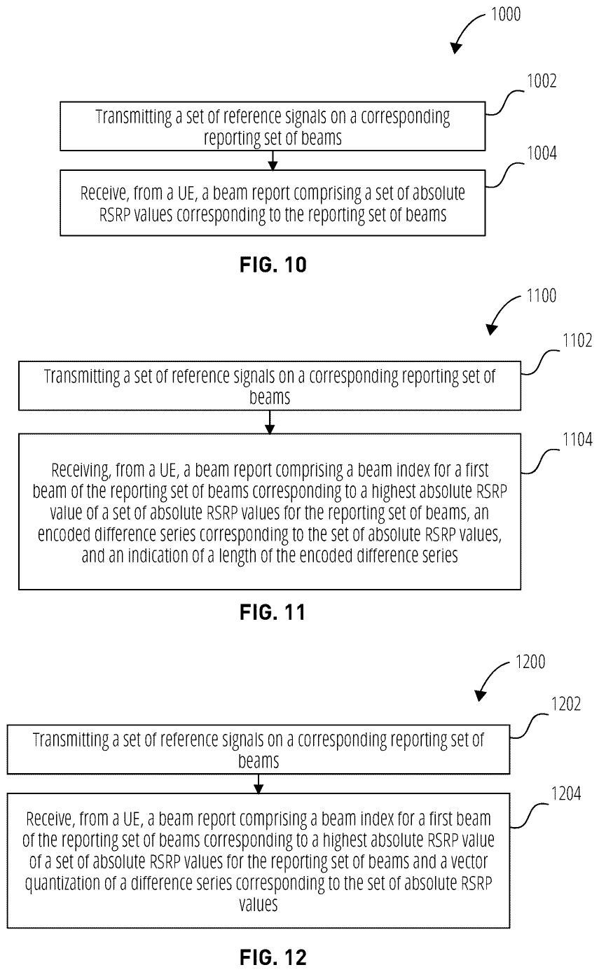

FIG. 10 illustrates a method 1000 of a RAN, according to embodiments discussed herein. The method 1000 includes transmitting 1002 a set of reference signals on a corresponding reporting set of beams. The method 1000 includes receiving 1004, from a UE, a beam report comprising a set of absolute RSRP values corresponding to the reporting set of beams.

In some embodiments of the method 1000, each absolute RSRP value in the set of absolute RSRP values is represented in the beam report using seven bits.

In some embodiments, the method 1000 further includes sending, to the UE, one of a MAC CE and RRC signaling indicating a number of bits to use to represent each absolute RSRP value of the set of absolute RSRP values in the beam report, and wherein each absolute RSRP value in the set of absolute RSRP values is represented in the beam report using the number of bits.

In some embodiments, the method 1000, further includes receiving, from the UE, a capability message indicating that the UE is capable of providing the beam report comprising the set of absolute RSRP values corresponding to the reporting set of beams.

In some embodiments of the method 1000, the reporting set of beams is equal to a transmission set of beams transmitted by the RAN.

In some embodiments of the method 1000, the reporting set of beams comprises a subset of a transmission set of beams transmitted by the RAN; and the beam report further comprises a bitmap that maps the set of absolute RSRP values corresponding to the reporting set of beams to the transmission set of beams.

In some embodiments, the method 1000 further includes sending, to the UE, configuration information for one or more subsets of a transmission set of beams transmitted by the network; wherein the beam report further includes an indication of a selection of a first subset of the one or more subsets of the transmission set of beams as the reporting set of beams.

In some embodiments of the method 1000, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

FIG. 11 illustrates a method 1100 of a RAN, according to embodiments discussed herein. The method 1100 includes transmitting 1102 a set of reference signals on a corresponding reporting set of beams. The method 1100 further includes receiving 1104, from a UE, a beam report comprising a beam index for a first beam of the reporting set of beams corresponding to a highest absolute RSRP value of a set of absolute RSRP values for the reporting set of beams, an encoded difference series corresponding to the set of absolute RSRP values, and an indication of a length of the encoded difference series.

In some embodiments, the method 1100 further includes receiving, from the UE, a capability message indicating that the UE is capable of providing the beam report comprising the beam index for the first beam, the encoded difference series, and the indication of the length of the encoded difference series.

In some embodiments of the method 1100, the reporting set of beams is equal to a transmission set of beams transmitted by the RAN.

In some embodiments of the method 1100, the reporting set of beams comprises a subset of a transmission set of beams transmitted by the RAN; and the beam report further comprises a bitmap that maps the set of absolute RSRP values corresponding to the reporting set of beams to the transmission set of beams.

In some embodiments, the method 1100 further includes sending, to the UE, configuration information for one or more subsets of a transmission set of beams transmitted by the network; wherein the beam report further includes an indication of a selection of a first subset of the one or more subsets of the transmission set of beams as the reporting set of beams.

In some embodiments of the method 1100, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

FIG. 12 illustrates a method 1200 of a RAN, according to embodiments discussed herein. The method 1200 includes transmitting 1202 a set of reference signals on a corresponding reporting set of beams. The method 1200 further includes receiving 1204, from a UE, a beam report comprising a beam index for a first beam of the reporting set of beams corresponding to a highest absolute RSRP value of a set of absolute RSRP values for the reporting set of beams and a vector quantization of a difference series corresponding to the set of absolute RSRP values.

In some embodiments, the method 1200 further includes receiving, from the UE, a capability message indicating that the UE is capable of providing the beam report comprising the beam index for the first beam and the vector quantization of the difference series.

In some embodiments of the method 1200, the reporting set of beams is equal to a transmission set of beams transmitted by the RAN.

In some embodiments of the method 1200, the reporting set of beams comprises a subset of a transmission set of beams transmitted by the RAN; and the beam report further comprises a bitmap that maps the set of absolute RSRP values corresponding to the reporting set of beams to the transmission set of beams.

In some embodiments, the method 1200 further includes sending, to the UE, configuration information for one or more subsets of a transmission set of beams transmitted by the network; wherein the beam report further includes an indication of a selection of a first subset of the one or more subsets of the transmission set of beams as the reporting set of beams.

In some embodiments of the method 1200, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

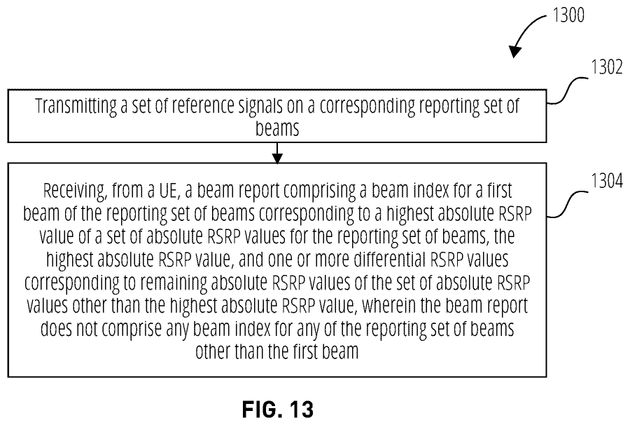

FIG. 13 illustrates a method 1300 of a RAN, according to embodiments discussed herein. The method 1300 includes transmitting 1302 a set of reference signals on a corresponding reporting set of beams. The method 1300 further includes receiving 1304, from a UE, a beam report comprising a beam index for a first beam of the reporting set of beams corresponding to a highest absolute RSRP value of a set of absolute RSRP values for the reporting set of beams, the highest absolute RSRP value, and one or more differential RSRP values corresponding to remaining absolute RSRP values of the set of absolute RSRP values other than the highest absolute RSRP value, wherein the beam report does not comprise any beam index for any of the reporting set of beams other than the first beam.

In some embodiments of the method 1300, an ordering within the beam report comprises first the beam index, then then highest absolute RSRP value, then the one or more differential RSRP values.

In some embodiments of the method 1300, an ordering within the beam report comprises first the beam index, then the one or more differential RSRP values, then the highest absolute RSRP value.

In some embodiments of the method 1300, an ordering within the beam report comprises first the beam index and then a set of RSRP values comprising the one or more differential RSRP values and the highest absolute RSRP value, wherein the set of RSRP values is ordered according to beam indexes of corresponding ones of the reporting set of beams.

In some embodiments of the method 1300, the highest absolute RSRP value is represented in the beam report using seven bits.

In some embodiments, the method 1300 further includes receiving, from the UE, a capability message indicating that the UE is capable of providing the beam report comprising the beam index for the first beam, the highest absolute RSRP value, and the one or more differential RSRP values.

In some embodiments of the method 1300, the reporting set of beams is equal to a transmission set of beams transmitted by the network.

In some embodiments of the method 1300, the reporting set of beams comprises a subset of a transmission set of beams transmitted by the RAN; and the beam report further comprises a bitmap that maps the set of absolute RSRP values corresponding to the reporting set of beams to the transmission set of beams.

In some embodiments, the method 1300 further includes sending, to the UE, configuration information for one or more subsets of a transmission set of beams transmitted by the network; wherein the beam report further includes an indication of a selection of a first subset of the one or more subsets of the transmission set of beams as the reporting set of beams.

In some embodiments of the method 1300, the reporting set of beams comprises a subset of a transmission set of beams transmitted by the network; and the beam report further comprises an index value of a combinatorial indexing mechanism that maps the set of absolute RSRP values corresponding to the reporting set of beams to the transmission set of beams.

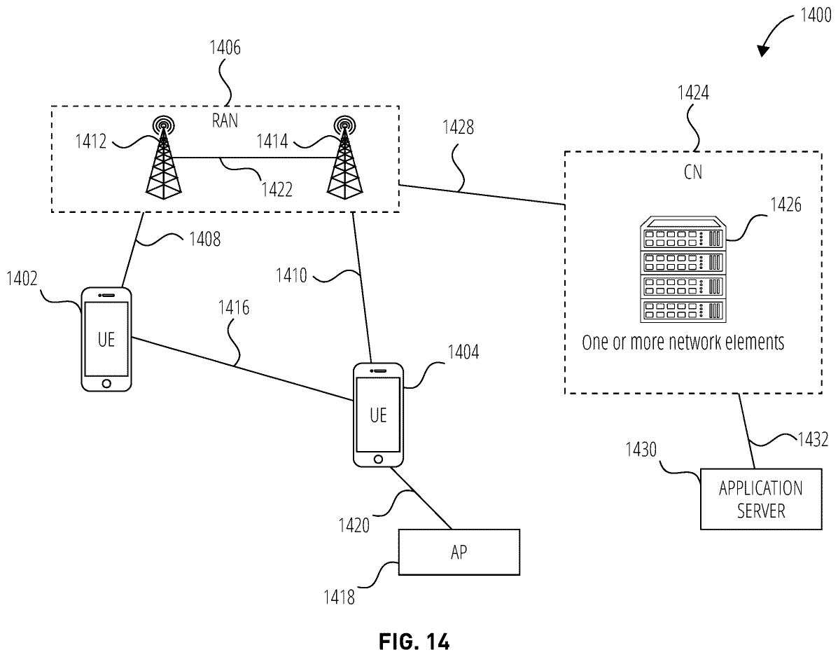

FIG. 14 illustrates an example architecture of a wireless communication system 1400, according to embodiments disclosed herein. The following description is provided for an example wireless communication system 1400 that operates in conjunction with the LTE system standards and/or 5G or NR system standards as provided by 3GPP technical specifications.

As shown by FIG. 14, the wireless communication system 1400 includes UE 1402 and UE 1404 (although any number of UEs may be used). In this example, the UE 1402 and the UE 1404 are illustrated as smartphones (e.g., handheld touchscreen mobile computing devices connectable to one or more cellular networks), but may also comprise any mobile or non-mobile computing device configured for wireless communication.

The UE 1402 and UE 1404 may be configured to communicatively couple with a RAN 1406. In embodiments, the RAN 1406 may be NG-RAN, E-UTRAN, etc. The UE 1402 and UE 1404 utilize connections (or channels) (shown as connection 1408 and connection 1410, respectively) with the RAN 1406, each of which comprises a physical communications interface. The RAN 1406 can include one or more base stations (such as base station 1412 and base station 1414) that enable the connection 1408 and connection 1410.

In this example, the connection 1408 and connection 1410 are air interfaces to enable such communicative coupling, and may be consistent with RAT(s) used by the RAN 1406, such as, for example, an LTE and/or NR.

In some embodiments, the UE 1402 and UE 1404 may also directly exchange communication data via a sidelink interface 1416. The UE 1404 is shown to be configured to access an access point (shown as AP 1418) via connection 1420. By way of example, the connection 1420 can comprise a local wireless connection, such as a connection consistent with any IEEE 802.11 protocol, wherein the AP 1418 may comprise a Wi-Fi® router. In this example, the AP 1418 may be connected to another network (for example, the Internet) without going through a CN 1424.

In embodiments, the UE 1402 and UE 1404 can be configured to communicate using orthogonal frequency division multiplexing (OFDM) communication signals with each other or with the base station 1412 and/or the base station 1414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1412 or base station 1414 may be implemented as one or more software entities running on server computers as part of a virtual network. In addition, or in other embodiments, the base station 1412 or base station 1414 may be configured to communicate with one another via interface 1422. In embodiments where the wireless communication system 1400 is an LTE system (e.g., when the CN 1424 is an EPC), the interface 1422 may be an X2 interface. The X2 interface may be defined between two or more base stations (e.g., two or more eNBs and the like) that connect to an EPC, and/or between two eNBs connecting to the EPC. In embodiments where the wireless communication system 1400 is an NR system (e.g., when CN 1424 is a 5GC), the interface 1422 may be an Xn interface. The Xn interface is defined between two or more base stations (e.g., two or more gNBs and the like) that connect to 5GC, between a base station 1412 (e.g., a gNB) connecting to 5GC and an eNB, and/or between two eNBs connecting to 5GC (e.g., CN 1424).

The RAN 1406 is shown to be communicatively coupled to the CN 1424. The CN 1424 may comprise one or more network elements 1426, which are configured to offer various data and telecommunications services to customers/subscribers (e.g., users of UE 1402 and UE 1404) who are connected to the CN 1424 via the RAN 1406. The components of the CN 1424 may be implemented in one physical device or separate physical devices including components to read and execute instructions from a machine-readable or computer-readable medium (e.g., a non-transitory machine-readable storage medium).

In embodiments, the CN 1424 may be an EPC, and the RAN 1406 may be connected with the CN 1424 via an S1 interface 1428. In embodiments, the S1 interface 1428 may be split into two parts, an S1 user plane (S1-U) interface, which carries traffic data between the base station 1412 or base station 1414 and a serving gateway (S-GW), and the S1-MME interface, which is a signaling interface between the base station 1412 or base station 1414 and mobility management entities (MMEs).

In embodiments, the CN 1424 may be a 5GC, and the RAN 1406 may be connected with the CN 1424 via an NG interface 1428. In embodiments, the NG interface 1428 may be split into two parts, an NG user plane (NG-U) interface, which carries traffic data between the base station 1412 or base station 1414 and a user plane function (UPF), and the S1 control plane (NG-C) interface, which is a signaling interface between the base station 1412 or base station 1414 and access and mobility management functions (AMFs).

Generally, an application server 1430 may be an element offering applications that use internet protocol (IP) bearer resources with the CN 1424 (e.g., packet switched data services). The application server 1430 can also be configured to support one or more communication services (e.g., VoIP sessions, group communication sessions, etc.) for the UE 1402 and UE 1404 via the CN 1424. The application server 1430 may communicate with the CN 1424 through an IP communications interface 1432.

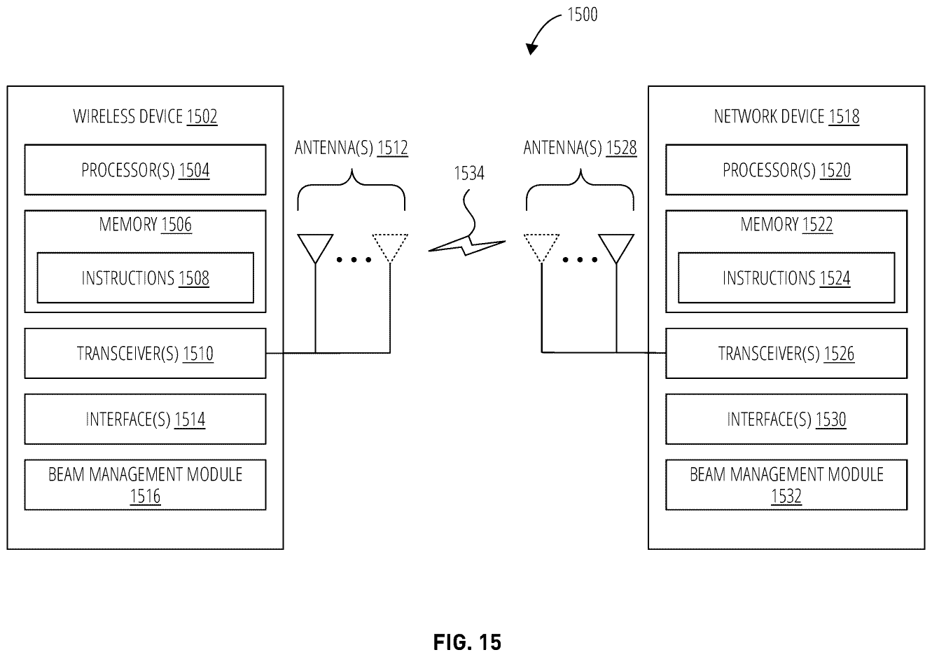

FIG. 15 illustrates a system 1500 for performing signaling 1534 between a wireless device 1502 and a network device 1518, according to embodiments disclosed herein. The system 1500 may be a portion of a wireless communications system as herein described. The wireless device 1502 may be, for example, a UE of a wireless communication system. The network device 1518 may be, for example, a base station (e.g., an eNB or a gNB) of a wireless communication system.

The wireless device 1502 may include one or more processor(s) 1504. The processor(s) 1504 may execute instructions such that various operations of the wireless device 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The wireless device 1502 may include one or more transceiver(s) 1510 that may include radio frequency (RF) transmitter and/or receiver circuitry that use the antenna(s) 1512 of the wireless device 1502 to facilitate signaling (e.g., the signaling 1534) to and/or from the wireless device 1502 with other devices (e.g., the network device 1518) according to corresponding RATs.

The wireless device 1502 may include one or more antenna(s) 1512 (e.g., one, two, four, or more). For embodiments with multiple antenna(s) 1512, the wireless device 1502 may leverage the spatial diversity of such multiple antenna(s) 1512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1502 may be accomplished according to precoding (or digital beamforming) that is applied at the wireless device 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The wireless device 1502 may include one or more interface(s) 1514. The interface(s) 1514 may be used to provide input to or output from the wireless device 1502. For example, a wireless device 1502 that is a UE may include interface(s) 1514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1510/antenna(s) 1512 already described) that allow for communication between the UE and other devices and may operate according to known protocols (e.g., Wi-Fi®, Bluetooth©, and the like).

The wireless device 1502 may include a beam management module 1516. The beam management module 1516 may be implemented via hardware, software, or combinations thereof. For example, the beam management module 1516 may be implemented as a processor, circuit, and/or instructions 1508 stored in the memory 1506 and executed by the processor(s) 1504. In some examples, the beam management module 1516 may be integrated within the processor(s) 1504 and/or the transceiver(s) 1510. For example, the beam management module 1516 may be implemented by a combination of software components (e.g., executed by a DSP or a general processor) and hardware components (e.g., logic gates and circuitry) within the processor(s) 1504 or the transceiver(s) 1510.

The beam management module 1516 may be used for various aspects of the present disclosure, for example, aspects of FIG. 1 through FIG. 13. The beam management module 1516 may be configured to configure the wireless device 1502 to generate a set of absolute RSRP values for a beam report, a (e.g., quantized/threshold-modified) difference series in for beam report, and/or differential RSRP values for a beam report that is used with an AI model, in the manners discussed herein (including with respect to cases where fewer than all transmitted beams are present in the beam report). The beam management module 1516 may also configure the wireless device 1502 to transmit the beam report as discussed herein.

The network device 1518 may include one or more processor(s) 1520. The processor(s) 1520 may execute instructions such that various operations of the network device 1518 are performed, as described herein. The processor(s) 1520 may include one or more baseband processors implemented using, for example, a CPU, a DSP, an ASIC, a controller, an FPGA device, another hardware device, a firmware device, or any combination thereof configured to perform the operations described herein.

The network device 1518 may include a memory 1522. The memory 1522 may be a non-transitory computer-readable storage medium that stores instructions 1524 (which may include, for example, the instructions being executed by the processor(s) 1520). The instructions 1524 may also be referred to as program code or a computer program. The memory 1522 may also store data used by, and results computed by, the processor(s) 1520.

The network device 1518 may include one or more transceiver(s) 1526 that may include RF transmitter and/or receiver circuitry that use the antenna(s) 1528 of the network device 1518 to facilitate signaling (e.g., the signaling 1534) to and/or from the network device 1518 with other devices (e.g., the wireless device 1502) according to corresponding RATs.

The network device 1518 may include one or more antenna(s) 1528 (e.g., one, two, four, or more). In embodiments having multiple antenna(s) 1528, the network device 1518 may perform MIMO, digital beamforming, analog beamforming, beam steering, etc., as has been described.

The network device 1518 may include one or more interface(s) 1530. The interface(s) 1530 may be used to provide input to or output from the network device 1518. For example, a network device 1518 that is a base station may include interface(s) 1530 made up of transmitters, receivers, and other circuitry (e.g., other than the transceiver(s) 1526/antenna(s) 1528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1518 may include a beam management module 1532. The beam management module 1532 may be implemented via hardware, software, or combinations thereof. For example, the beam management module 1532 may be implemented as a processor, circuit, and/or instructions 1524 stored in the memory 1522 and executed by the processor(s) 1520. In some examples, the beam management module 1532 may be integrated within the processor(s) 1520 and/or the transceiver(s) 1526. For example, the beam management module 1532 may be implemented by a combination of software components (e.g., executed by a DSP or a general processor) and hardware components (e.g., logic gates and circuitry) within the processor(s) 1520 or the transceiver(s) 1526.

The beam management module 1532 may be used for various aspects of the present disclosure, for example, aspects of FIG. 1 through FIG. 13. The beam management module 1532 may be configured to configure the network device 1518 to use a set of absolute RSRP values in a beam report, a (e.g., quantized/threshold-modified) difference series in a beam report, and/or differential RSRP values in a beam report that is used with an AI model, in the manners discussed herein (including with respect to cases where fewer than all transmitted beams are present in the beam report).

Embodiments contemplated herein include an apparatus comprising means to perform one or more elements of any of the method 600, the method 700, the method 800, and/or the method 900. This apparatus may be, for example, an apparatus of a UE (such as a wireless device 1502 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 600, the method 700, the method 800, and/or the method 900. This non-transitory computer-readable media may be, for example, a memory of a UE (such as a memory 1506 of a wireless device 1502 that is a UE, as described herein).

Embodiments contemplated herein include an apparatus comprising logic, modules, or circuitry to perform one or more elements of any of the method 600, the method 700, the method 800, and/or the method 900. This apparatus may be, for example, an apparatus of a UE (such as a wireless device 1502 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 600, the method 700, the method 800, and/or the method 900. This apparatus may be, for example, an apparatus of a UE (such as a wireless device 1502 that is a UE, as described herein).

Embodiments contemplated herein include a signal as described in or related to one or more elements of any of the method 600, the method 700, the method 800, and/or the method 900.

Embodiments contemplated herein include a computer program or computer program product comprising instructions, wherein execution of the program by a processor is to cause the processor to carry out one or more elements of any of the method 600, the method 700, the method 800, and/or the method 900. The processor may be a processor of a UE (such as a processor(s) 1504 of a wireless device 1502 that is a UE, as described herein). These instructions may be, for example, located in the processor and/or on a memory of the UE (such as a memory 1506 of a wireless device 1502 that is a UE, as described herein).

Embodiments contemplated herein include an apparatus comprising means to perform one or more elements of any of the method 1000, the method 1100, the method 1200, and/or the method 1300. This apparatus may be, for example, an apparatus of a base station (such as a network device 1518 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 1000, the method 1100, the method 1200, and/or the method 1300. This non-transitory computer-readable media may be, for example, a memory of a base station (such as a memory 1522 of a network device 1518 that is a base station, as described herein).

Embodiments contemplated herein include an apparatus comprising logic, modules, or circuitry to perform one or more elements of any of the method 1000, the method 1100, the method 1200, and/or the method 1300. This apparatus may be, for example, an apparatus of a base station (such as a network device 1518 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 1000, the method 1100, the method 1200, and/or the method 1300. This apparatus may be, for example, an apparatus of a base station (such as a network device 1518 that is a base station, as described herein).

Embodiments contemplated herein include a signal as described in or related to one or more elements of any of the method 1000, the method 1100, the method 1200, and/or the method 1300.

Embodiments contemplated herein include a computer program or computer program product comprising instructions, wherein execution of the program by a processing element is to cause the processing element to carry out one or more elements of any of the method 1000, the method 1100, the method 1200, and/or the method 1300. The processor may be a processor of a base station (such as a processor(s) 1520 of a network device 1518 that is a base station, as described herein). These instructions may be, for example, located in the processor and/or on a memory of the base station (such as a memory 1522 of a network device 1518 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
measuring a set of reference signals transmitted by a network on a corresponding reporting set of beams to determine a set of absolute reference signal received power (RSRP) values corresponding to the reporting set of beams; and
sending, to the network, a beam report comprising the set of absolute RSRP values corresponding to the reporting set of beams.

2. The method of claim 1, wherein each absolute RSRP value in the set of absolute RSRP values is represented in the beam report using seven bits.

3. The method of claim 1, further comprising receiving, from the network, one of a medium access control control element (MAC CE) and radio resource control (RRC) signaling indicating a number of bits to use to represent each absolute RSRP value of the set of RSRP values in the beam report, and wherein each absolute RSRP value in the set of absolute RSRP values is represented in the beam report using the number of bits.

4. The method of claim 1, further comprising sending, to the network, a capability message indicating that the UE is capable of providing the beam report comprising the set of absolute RSRP values corresponding to the reporting set of beams.

5. The method of claim 1, wherein the reporting set of beams is equal to a transmission set of beams transmitted by the network.

6. The method of claim 1, wherein:
the reporting set of beams comprises a subset of a transmission set of beams transmitted by the network; and
the beam report further comprises a bitmap that maps the set of absolute RSRP values corresponding to the reporting set of beams to the transmission set of beams.

7. The method of claim 1, further comprising:
receiving, from the network, configuration information for one or more subsets of a transmission set of beams transmitted by the network; and
selecting a first subset of the one or more subsets of the transmission set of beams as the reporting set of beams;
wherein the beam report further includes an indication of the selection of the first subset of the one or more subsets of the transmission set of beams as the reporting set of beams.

8. The method of claim 1, wherein:
the reporting set of beams comprises a subset of a transmission set of beams transmitted by the network; and
the beam report further comprises an index value of a combinatorial indexing mechanism that maps the set of absolute RSRP values corresponding to the reporting set of beams to the transmission set of beams.

9. A method of a user equipment (UE), comprising:
measuring a set of reference signals transmitted by a network on a corresponding reporting set of beams to determine a set of absolute reference signal received power (RSRP) values corresponding to the reporting set of beams;
generating a difference series using the set of absolute RSRP values, the difference series using a highest absolute RSRP value of the set of absolute RSRP values as a reference;
performing a quantization of the difference series;
generating an encoded difference series by encoding the difference series after the quantization of the difference series is performed; and
sending, to the network, a beam report comprising a beam index for a first beam of the reporting set of beams corresponding to the highest absolute RSRP value of the set of absolute RSRP values, the encoded difference series, and an indication of a length of the encoded difference series.

10. The method of claim 9, further comprising setting any values in the difference series that are lower than a minimum threshold value to the minimum threshold value prior to performing the quantization of the difference series.

11. The method of claim 9, wherein the quantization of the difference series is performed using a uniform quantizer.

12. The method of claim 9, wherein the quantization of the difference series is performed using a non-uniform quantizer that is relatively sparser around the minimum threshold value.

13. The method of claim 9, wherein the difference series is encoded to generate the encoded difference series using one of a Lemple-Ziv coding technique and a Huffman coding technique.

14. The method of claim 9, further comprising sending, to the network, a capability message indicating that the UE is capable of providing the beam report comprising the beam index for the first beam, the encoded difference series, and the indication of the length of the encoded difference series.

15. The method of claim 9, wherein the reporting set of beams is equal to a transmission set of beams transmitted by the network.

16. The method of claim 9, wherein:
the reporting set of beams comprises a subset of a transmission set of beams transmitted by the network; and
the beam report further comprises a bitmap that maps the set of absolute RSRP values corresponding to the reporting set of beams to the transmission set of beams.

17. The method of claim 9, further comprising:
receiving, from the network, configuration information for one or more subsets of a transmission set of beams transmitted by the network; and
selecting a first subset of the one or more subsets of the transmission set of beams as the reporting set of beams;
wherein the beam report further includes an indication of the selection of the first subset of the one or more subsets of the transmission set of beams as the reporting set of beams.

18. The method of claim 9, wherein:
the reporting set of beams comprises a subset of a transmission set of beams transmitted by the network; and
the beam report further comprises an index value of a combinatorial indexing mechanism that maps the set of absolute RSRP values corresponding to the reporting set of beams to the transmission set of beams.

19. A method of a user equipment (UE), comprising:
measuring a set of reference signals transmitted by a network on a corresponding reporting set of beams to determine a set of absolute reference signal received power (RSRP) values corresponding to the reporting set of beams;
generating a difference series using the set of absolute RSRP values, the difference series using a highest absolute RSRP value of the set of absolute RSRP values as a reference;
performing a vector quantization of the difference series; and
sending, to the network, a beam report comprising a beam index for a first beam of the reporting set of beams corresponding to the highest absolute RSRP value of the set of RSRP values and the vector quantization of the difference series.

20. The method of claim 19, further comprising setting any values in the difference series that are lower than a minimum threshold value to the minimum threshold value prior to the vector quantization of the difference series.

21-71. (canceled)
